(19) United States
(12) Patent Application Publication
(10) Pub. No.: US 2016/0016275 A1
(43) Pub. Date: Jan. 21, 2016

(54) TIRE GRINDING DEVICE AND TIRE TESTING SYSTEM

(71) Applicant: MITSUBISHI HEAVY INDUSTRIES MACHINERY TECHNOLOGY CORPORATION, Hiroshima (JP)

(72) Inventors: Tatsuya UEDA, Hiroshima-shi, Hiroshima (JP); Makoto TACHIBANA, Hiroshima-shi, Hiroshima (JP)

(73) Assignee: Mitsubishi Heavy Industries Machinery Technology Corporation

(21) Appl. No.: 14/776,838

(22) PCT Filed: Nov. 28, 2013
(86) PCT No.: PCT/JP2013/082071

§ 371 Date: Sep. 15, 2015

(51) Int. Cl. B24B 5/36; G01B 21/20; G01M 17/02; G01M 1/16; B24B 49/02; B24B 55/06

(52) U.S. Cl. CPC B24B 5/366; B24B 49/02; B24B 55/06; G01M 17/02; G01M 1/16; G01B 21/20

(57) ABSTRACT

A tire grinding device grinds a surface of a tire, and the tire grinding device includes: a grindstone holding portion which holds a grindstone which grinds the surface of the tire; a cover which is disposed with a gap with respect to the surface of the tire, and covers the grindstone held by the grindstone holding portion; and an air layer forming portion which forms an air layer which prevents ground chips of the ground tire from being discharged through the gap formed between an edge of the cover and the surface of the tire.

### RELATED APPLICATIONS

The present application is a National Phase of International Application Number PCT/JP2013/082071, filed Nov. 28, 2013.

### TECHNICAL FIELD

The present invention relates to a tire grinding device and a tire testing system.

### BACKGROUND ART

In general, in a manufactured tire, uniformity during a travelling state in the tire is inspected using an inspection device such as a tire uniformity machine. In addition, when the surface of the tire is non-uniform, the surface of the tire is ground using a grinder, and thereafter, the tire in which the surface is uniform is shipped.

As grinder devices which grinds the surface of the tire, a grinder device is suggested, which includes a grindstone which grinds a surface of a tire, a shroud which removes particles generated when the grindstone grinds the tire, and a jet nozzle which supplies a fluid to the tire (refer to PTL 1 below).

In the grinder device, the grindstone grinds the surface of the tire, ground chips (particles) generated when the surface of the tire is ground are introduced into the shroud, and the ground chips entering grooves of the tire are removed by the fluid supplied from the jet nozzle.

### CITATION LIST

### Patent Literature

[PTL 1] Japanese Unexamined Patent Application Publication No. 2002-144208

### SUMMARY OF INVENTION

### Technical Problem

However, in the grinder device disclosed in PTL 1, even when it is possible to remove the ground chips in the shroud, it is likely that labor and cost will have to be increased in order to remove the ground chips which are scattered in a gap between the shroud and the tire to the outside of the shroud.

The present invention provides a tire grinding device and a tire testing system capable of preventing the ground chips from being scattered when the tire is ground.

### Solution to Problem

(1) According to an aspect of the invention, there is provided a tire grinding device which grinds a surface of a tire, including a grindstone holding portion which holds a grindstone which grinds the surface of the tire, a cover which is disposed with a gap with respect to the surface of the tire, and covers the grindstone held by the grindstone holding portion, and an air layer forming portion which forms an air layer which prevents ground chips of the ground tire from being discharged through the gap formed between an edge of the cover and the surface of the tire.

According to the configuration, the ground chips, which are scattered toward the gap between the edge of the cover and the surface of the tire when the grindstone held by the grindstone holding portion grinds the tire, are prevented from being discharged from the gap by the air layer formed by the air layer forming portion. Accordingly, it is possible to prevent the ground chips from being scattered when the tire is ground.

(2) In the tire grinding device according to (1), the air layer forming portion may inject air toward the gap.

According to the configuration, the air layer forming portion injects the air toward the gap between the edge of the cover and the surface of the tire, and thus, the air layer is formed in the gap. That is, since the ground chips to be scattered to the outside of the cover from the gap are pushed back by the air injected to the gap, it is possible to prevent the ground chips from being scattered to the outside of the cover.

(3) In the tire grinding device according to (1) or (2), the air layer forming portion may inject the air toward the gap so that the air is gradually directed to the grindstone side toward the tire.

According to the configuration, since the ground chips scattered from the portion between the tire and the grindstone are pushed back toward the grindstone side by the air which is injected so as to be gradually directed to the grindstone side toward the tire, it is possible to prevent the ground chips from being scattered.

(4) In the tire grinding device according to (2) or (3), the air layer forming portion may be provided so as to inject the air to at least a front side gap in a grinding direction in the gap.

According to the configuration, the ground chips generated between the tire and the grindstone are mainly scattered to the front side in the grinding direction. Here, according to the injection of the air by the air layer forming portion, the air layer is formed at least on the front side in the grinding direction on which the ground chips are mainly scattered. Accordingly, it is possible to effectively prevent the ground chips from being scattered.

(5) In the tire grinding device according to any one of (2) to (4), the air layer forming portion may inject the air toward the gap from the outside of the cover.

According to the configuration, since the air is injected from the outside of the cover toward the inside thereof, it is possible to effectively prevent the ground chips, which are directed to the outside of the cover through the gap from the inside of the cover, from being scattered.

(6) In the tire grinding device according to any one of (1) to (5), the grindstone holding portion may hold the grindstone so as to grind a shoulder portion of the tire.

According to the configuration, also in the shoulder portion of the tire in which the gap is easily formed between the cover and the shoulder portion, it is possible to effectively prevent the ground chips from being scattered.

(7) The tire grinding device according to any one of (1) to (6) may further include a static electricity removing portion which removes static electricity on the surface of the tire.

According to the configuration, attachment of the ground chips to the tire due to static electricity is prevented by the static electricity removing portion, and it is possible to prevent the ground chips from being attached to the tire, being scattered around the tire, or being transported to the subsequent location in the process along with the tire.

(8) In the tire grinding device according to (7), the ionized air may be injected toward the gap, and may also serve as the static electricity removing portion which removes the static electricity on the surface of the tire using the injected ionized air.

According to the configuration, since the air layer forming portion also plays the role of the static electricity removing portion, unlike in a case where the air layer forming portion forming the air layer and the static electricity removing portion removing the static electricity are separately provided, it is possible to achieve a compact configuration.

(9) According to an another aspect of the invention, there is provided a tire testing system, including a tire grinding device according to any one of (1) to (8), and a surface measurement device which measures the shape of the surface of the tire.

According to the configuration, the surface of the tire is measured by the surface measurement device, the tire is ground based on the measured results while the scattering of the ground chips is prevented, and thus, it is possible to form the tire in a predetermined shape.

### Advantageous Effects of Invention

According to the above-described tire grinding device and tire testing system, it is possible to prevent ground chips from being scattered when the tire is ground.

### BRIEF DESCRIPTION OF DRAWINGS

FIG. 1 is a schematic front view showing a configuration of a tire testing system according to the present embodiment.

FIG. 2 is a view when viewed from A direction of FIG. 1.

FIG. 3 is a view when viewed from B direction of FIG. 1.

FIG. 4 is a view corresponding to the view when viewed from the B direction of FIG. 1 in a tire testing system according to a first modification example of the present embodiment.

FIG. 5 is a view when a main portion is viewed from the A direction of FIG. 1 in a tire testing system according to a second modification example of the present embodiment.

FIG. 6 is a view corresponding to the view when viewed from the A direction of FIG. 1 in a tire testing system according to a third modification example of the present embodiment.

### DESCRIPTION OF EMBODIMENTS

Hereinafter, an embodiment of the present invention will be described.

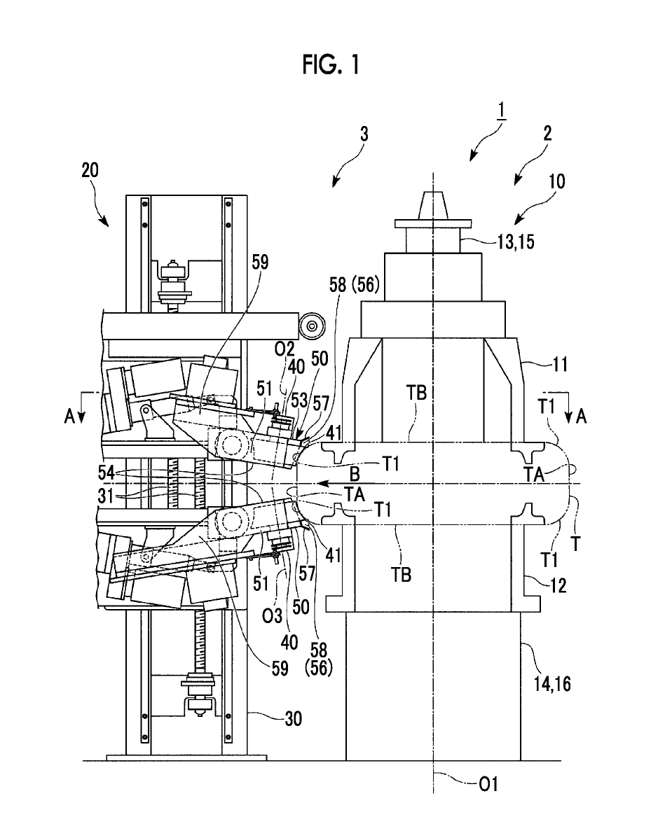

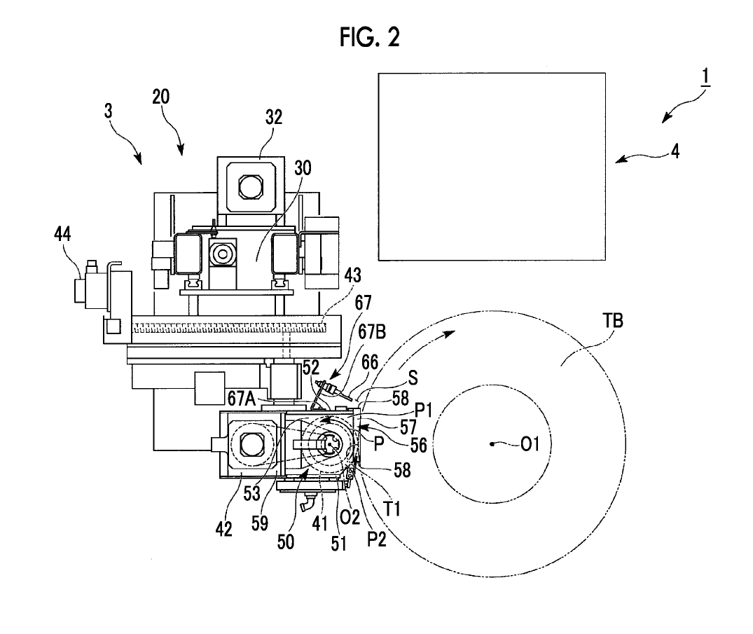

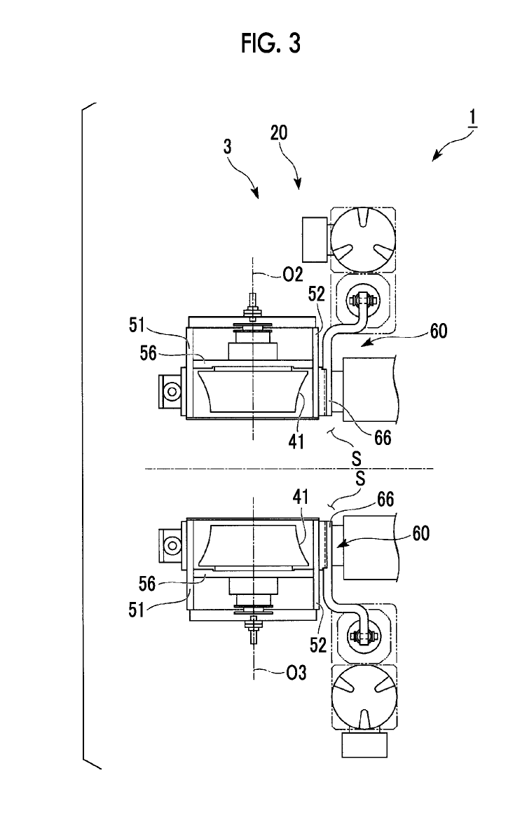

As shown in FIGS. 1 to 3, a tire testing system 1 of the present embodiment includes a tire uniformity machine 2 (surface measurement device) which measures the shape of a surface of a tire T, for example, uniformity of the tire T, and a tire grinding device 3 which grinds the surface of the tire T when the tire T is non-uniform.

Here, in the tire T, a portion which becomes a circumferential surface coming into contact with a ground surface when a vehicle travels is a tread portion TA. In addition, a portion which intersects the tread portion TA and becomes a side surface formed in an annular shape is a side wall portion TB. A portion between the tread portion TA and a side wall portion TB is a shoulder portion T1.

The tire uniformity machine 2 includes a tire rotation holding body 10 which rotatably holds the tire T, and a measurement portion 4 which measures the uniformity of the surface of the tire T.

(Tire Rotation Holding Body)

The tire rotation holding body 10 includes a first rim 11 and a second rim 12 which hold the tire T in a width direction.

The first rim 11 is disposed so as to come into close contact with a bead portion (not shown) on one side in the width direction (an up-down direction on a paper surface shown in FIG. 1) of the tire T. The second rim 12 is disposed so as to come into close contact with the bead portion (not shown) on the other side in the width direction of the tire T. The tire t is interposed between the first rim 11 and the second rim 12 in the width direction.

The first rim 11 is attached to a first rim shaft 15 which is rotatable around an axial line O1. The second rim 12 is attached to a second rim shaft 16 which can be rotated and driven around the axial line O1.

The tire rotation holding body 10 includes a first rim driving portion 13 which moves the first rim shaft 15 in the width direction of the tire T, and a second rim rotating and driving portion 14 which rotates and drives the second rim shaft 16.

In the tire rotation holding portion 10, the first rim shaft 15 is moved in a direction, in which the shaft approaches the tire T, by the first rim driving portion 13, and thus, the first rim 11 approaches the tire T. In addition, the tire T is interposed between the first rim 11 and the second rim 12 in the width direction. In this state, movement of the first rim shaft 15 and the second rim shaft 16 are regulated by a lock mechanism (not shown). Next, the second rim 12 is rotated and driven along with the second rim shaft 16 by the second rim rotating and driving portion 14. Accordingly, the first rim 11 which is rotatably configured is driven, and thus, the first rim 11 and the second rim 12 are simultaneously rotated. That is, the tire T which is interposed between the first rim 11 and the second rim 12 is rotated.

Moreover, in the above-described rotation mechanism, a driving force is applied to both the first rim shaft 15 and the second rim shaft 16, and the rotational speeds may be synchronized with each other. In addition, in another rotation mechanism, the driving force is applied to only one of the first rim shaft 15 or the second rim shaft 16, and the other may be driven by the one which is driven.

In the state where the tire T is rotatably held by the tire rotation holding body 10, the measurement portion 4 measures radial run out (RRO) indicating non-uniformity of dimensions of the tire T, radial force variation indicating variation of a force in a radial direction, or the like.

(Tire Grinding Device)

The tire grinding device 3 includes the above-described tire rotation holding body 10, and a grindstone holding body 20 in which a grindstone 41 grinding the surface of the tire T is provided. The above-described tire rotation holding body 10 of the tire uniformity machine 2 also serves as the tire rotation holding body 10 of the tire grinding device 3.

(Grindstone Holding Body)

The grindstone holding body 20 includes a support body 30 which extends upward from a floor surface, a grindstone holding portion 40 which is supported by the support body 30 and rotatably holds the grindstone 41, ball screws 31 and 43 which move the grindstone holding portion 40, a cover 50 which covers the grindstone 41, and an air layer forming portion 60 which prevents ground chips generated from the tire T from being scattered.

(Support Body)

In the support body 30, a pair of the ball screws 31 which extends in the width direction of the tire T is provided so as to be separated from each other in a width direction (a direction approaching and separating from the tire T) of the support body 30, that is, a radial direction (right-left direction shown in FIG. 1) of the tire T. The ball screws 31 configure a ball screw mechanism or a sliding screw mechanism which converts a rotational movement into a liner movement in the up-down direction (the width direction of the tire T). The ball screws 31 are connected to a motor 32 and the ball screws 31 can be rotated by driving of the motor 32.

In the support body 30, a pair of the ball screws 43 extending in the radial direction of the tire T is provided so as to be separated from each other in the width direction of the tire T. The ball screws 43 configure the ball screw mechanism or the sliding screw mechanism which converts the rotational movement into a liner movement in the radial direction of the tire T. The ball screws 43 are connected to a motor 44 and the ball screws 43 can be rotated by driving the motor 44.

(Grindstone Holding Portion)

A pair of the grindstone holding portions 40 is provided so as to be separated from each other in the width direction of the tire T. The grindstone holding portion 40 is provided on each of the pair of ball screws 31. The grindstone holding portion 40 is movable in the width direction of the tire T according to an amount of rotation of the ball screw 31. That is, each of the grindstone holding portions 40 is movable in the width direction of the tire T according to the amount of rotation of each of the ball screws 31.

In addition, the grindstone holding portion 40 is provided on each of the pair of ball screws 43. The grindstone holding portion 40 is movable in the radial direction of the tire T according to the amount of rotation of the ball screw 43. That is, each grindstone holding portion 40 is movable in the radial direction of the tire T according to the amount of rotation of each of the ball screws 43.

The grindstone holding portion 40 rotates the grindstone 41 which grinds the surface of the tire T by driving a motor 42.

The grindstones 41 are disposed about axial lines O2 and O3 which are gradually inclined toward the tire T side while going toward a direction separated from the center in the width direction of the tire T. A sectional shape of the grindstone 41 orthogonal to each of the axial lines O2 and O3 is a circular shape, and the diameter dimension of the grindstone 41 decreases toward the center side in the width direction of the tire T. In addition, in the shape of the grindstone, the sectional shape orthogonal to each of the axial lines O2 and O3 is a circular shape, and may be a columnar shape extending along each of the axial lines O2 and O3.

The grindstone holding portion 40 rotatably supports the grindstone 41 about each of the axial lines O2 and O3. Accordingly, the grindstone 41 can grind the shoulder portion T1 of the tire T. The grindstone 41 held by the grindstone holding portion 40 is disposed at a position at which the grindstone 41 can come into contact with the tire T.

In the present embodiment, the tire T rotates about the axial line O1, and the grindstone 41 rotates in the direction opposite to the rotation direction of the tire T about each of the axial lines O2 and O3. In addition, the rotational speed of the grindstone 41 is faster than the rotational speed of the tire T. Accordingly, in the present embodiment, the grindstone 41 moves with respect to the tire T, the movement direction of the grindstone 41 on the circumferential surface of the tire T at the contact portion between the tire T and the grindstone 41 is set to the grinding direction P, and the shoulder portion T1 of the tire T is ground. Here, in the contact portion between the grindstone 41 and the tire T, the side of the grindstone 41 which moves with respect to the circumferential surface of the tire T is defined as a front side P1, and the side opposite to the front side is defined as a rear side P2.

(Cover)

The cover 50 includes a first wall portion 51 which covers the rear side P2 in the grinding direction of the grindstone 41, a second wall portion 52 which covers the front side P1 in the grinding direction, a third wall portion 53 which covers the side separated from the center in the width direction of the tire T between the end portions of the first wall portion 51 and the second wall portion 52, and a fourth wall portion 54 which covers the center side in the width direction of the tire T between the end portions of the first wall portion 51 and the second wall portion 52. A protrusion portion 56 which extends toward the tire T side is provided on the third wall portion 53.

The protrusion portion 56 is formed so as to be continuous with the third wall portion 53, and includes a protrusion cover portion 57 which extends to the tire T side and a pair of hanging portions 58 which is suspended from both ends in the grinding direction of the tire T in the protrusion cover portion 57.

The first wall portion 51, the second wall portion 52, the third wall portion 53, and the fourth wall portion of the cover 50, and the cover portion 57 and the hanging portion 58 of the protrusion portion 56 are disposed so as to cover the periphery of the grindstone 41.

The grindstone 41 is formed in a disk shape, and is disposed so that a portion of the grindstone 41 is exposed to the tire T side from the end portion of the first wall portion 51 and the end portion of the second wall portion 52 of the cover 50. In addition, the tire T is disposed so as to be separated from the cover 50. Accordingly, a gap S is formed between the edge of the cover 50 and the surface of the tire T.

Specifically, the gap S is formed between the surface of the tire T and the end portion of the first wall portion 51 of the cover 50, between the surface of the tire T and the end portion of the second wall portion 52, between the surface of the tire T and the end portion of the third wall portion 53, between the surface of the tire T and the fourth wall portion 54, between the surface of the tire T and the protrusion portion 56, and over the front side in the grinding direction and the rear side in the grinding direction from the shoulder portion T1 of the tire T.

A duct 59 connected to the cover 50 is provided on the side opposite to the tire T side of the cover 50. In addition, a suction portion (not shown) which sucks air into the duct 59 is provided on the side opposite to the tire T in the duct 59.

(Air Layer Forming Portion)

The air layer forming portion 60 includes a nozzle 66 which is connected to an air source (not shown) which can supply air.

The nozzle 66 is formed in a tapered shape, and is attached to the cover 50 via a mounting stand 67 provided on the second wall portion 52 of the cover 50. The mounting stand 67 includes a fixing portion 67A which is provided along the second wall portion 52 of the cover 50, and a nozzle support portion 67B which extends toward the tire T side while going toward the front side P1 in the grinding direction from the fixing portion 67A and supports the nozzle 66.

The rear end side of the nozzle 66 is supported by the nozzle support portion 67B, and the tip thereof is disposed so as to be directed to the gap S. An air layer is formed by the air injected from the nozzle 66, and the air layer prevents the ground chips of the tire T from being discharged from the gap S formed between the edge of the cover 50 and the surface of the tire T.

In the present embodiment, the tip of the nozzle 66 is disposed so as to be gradually directed to the grindstone 41 side toward the tire T. In order words, the tip of the nozzle 66 is disposed so as to be gradually directed to the rear side P2 in the grinding direction toward the tire T. In addition, the nozzle 66 is disposed so as to inject the air toward the portion of the front side P1 in the grinding direction from the shoulder portion T1 in the gap S extending in the grinding direction in the state where the shoulder portion T1 of the tire T which is the contact surface between the grindstone 41 and the tire T is interposed.

Next, an operation of the tire testing system 1 configured in this way will be described.

First, the tire T is disposed so as to come into close contact with the second rim 12 of the tire rotation holding body 10. In addition, the first rim driving portion 13 is driven, and the first rim shaft 15 is moved in the direction approaching the tire T. Accordingly, the first rim 11 provided on the first rim shaft 15 approaches the tire T. Moreover, the tire T is interposed between the first rim 11 and the second rim 12 in the width direction. In this state, the second rim rotating and driving portion 14 rotates and drives the second rim 12 along with the second rim shaft 16. Accordingly, the first rim 11 which is rotatably configured is driven, the first rim 11 and the second rim 12 simultaneously rotate around the axial line O1, and thus, the tire T rotates.

In this state, the measurement portion 4 measures the uniformity of the tire T. When the measured results are within an allowable range, the operation of the tire testing system 1 ends or the operation is transferred to work for measuring the uniformity of the next tire T.

Meanwhile, when the measured results of the tire T are outside the allowable range, the shoulder portion T1 of the tire T is ground.

That is, the ball screws 31 and 43 of the grindstone holding portion 20 are rotated, the grindstone holding portion 40 moves in the width direction and the radial direction of the tire T according to the amount of rotation of the ball screw 31, and the grindstone 41 is disposed at the position corresponding to each shoulder portion T1 formed on the end portion in the width direction of the tire T. In addition, the grindstone holding portions 40 rotate the grindstones 41 around the axial lines O2 and O3.

In this way, the tire T and the grindstones 41 rotate in the state where the tire T and the grindstone 41 come into contact with each other, the grindstones 41 grind the surface of the tire T, and the ground chips are generated from the surface of the tire T. The suction portion provided in the duct 59 sucks the air in the duct 59, and thus, the ground chips, which are scattered toward the inside of the cover 50, are sucked into the cover 50 connected to the duct 59.

Meanwhile, the ground chips which are scattered toward the gap S of the front side P1 in the grinding direction are pushed back to the grindstone 41 side by the air injected from the tip of the nozzle 66 of the air layer forming portion 60 toward the gap S, and thus, are introduced into the cover 50 and sucked into the duct 59.

In the above-described tire testing system 1, the ground chips of the tire T are sucked into the duct 59 by the air injected from the tip of the nozzle 66 toward the gap S. Accordingly, the scattering of the ground chips are prevented.

Moreover, since the rotational speed of the grindstone 41 is faster than the rotational speed of the tire T, the ground chips are mainly scattered toward the front side in the rotation direction of the tire T from the contact surface between the tire T and the grindstone 41, and toward the gap S on the front side in the rotation direction of the grindstone 41. Since the air is injected from the tip of the nozzle 66 to the gap S on the front side P1 in the grinding direction in which the ground chips are scattered, it is possible to effectively prevent the ground chips from being scattered.

In addition, in the above-described embodiment, the nozzle 66 is disposed on the front side in the grinding direction of the shoulder portion T1 which is the contact surface between the grindstone 41 and the tire T. However, the present invention is not limited to this. As long as the air layer, which prevents the ground chips from being discharged from the gap S formed between the edge of the cover 50 and the surface of the tire T, is formed, the nozzle 66 can be disposed so that the tip of the nozzle 66 is directed toward the gap S of the side separated from the center in the width direction of the tire T of the shoulder portion T1, the gap S on the rear side P2 in the grinding direction of the shoulder portion T1, or the like.

### FIRST MODIFICATION EXAMPLE

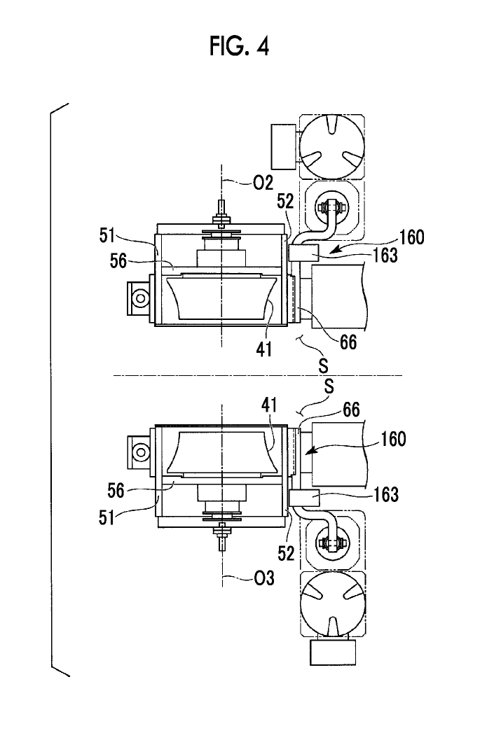

Next, a first modification example of the above-described embodiment will be described mainly with reference to FIG. 4.

An ionizer (static electricity removing portion) is provided on an air layer forming portion 160 according to the first modification example.

In this modification example, the same reference numerals are assigned to the same members as the members used in the above-described embodiment, and descriptions thereof are omitted.

For example, the air source supplies air such as nitrogen gas or the like. An ionizer 163 ionizes nitrogen gas supplied from the air source, and generates ionized nitrogen gas.

In the above-described configuration, attachment of the ground chips to the tire T due to the static electricity is prevented by the ionized air injected from the nozzle 66, and it is possible to prevent the ground chips from being attached to the tire T and being scattered to the periphery of the tire T, or it is possible to prevent the ground chips from being transported to the subsequent location in the process along with the tire T.

Moreover, the ionized air injected from the nozzle 66 plays a role of introducing the ground chips into the cover 50, and also plays a role of preventing the ground chips from being attached to the tire T. Accordingly, unlike in a case where each nozzle 66 or each air source is provided to realize each role by separated air, the configuration can be compact.

Moreover, the shapes, the combinations, or the like of constituent members shown in the above-described embodiment are only examples, and various modification examples can be applied based on design requests or the like within a range which does not depart from the gist of the present invention.

In addition, the above-described embodiment, the nozzle 66 has a tapered shape. However, the embodiment of the present invention is not limited to this. For example, the nozzle 66 may have a width in the width direction of the tire T, the grinding direction, or the direction which spans from the grindstone 41 side to the tire T side. In this case, since it is possible to inject air over the width direction of the nozzle, it is possible to form the air layer having an appropriate width corresponding to the size of the gap S.

Moreover, in the above-described first modification example, the ionized air injected from the nozzle 66 prevents the ground chips of the tire T from being discharged from the gap S and removes the static electricity. However, the embodiment of the present invention is not limited to this. The air which prevents the ground chips of the tire T from being discharged from the gap S and the air which removes the static electricity may be supplied from separated nozzles.

Moreover, in the above-described embodiment, for example, the tire uniformity machine which measures the shape of the surface of the tire T is described as the surface measurement device. However, the embodiment of the present invention is not limited to this. For example, the surface measurement device may include a dynamic imbalance machine which measures imbalance of the tire, or the like.

### SECOND MODIFICATION EXAMPLE

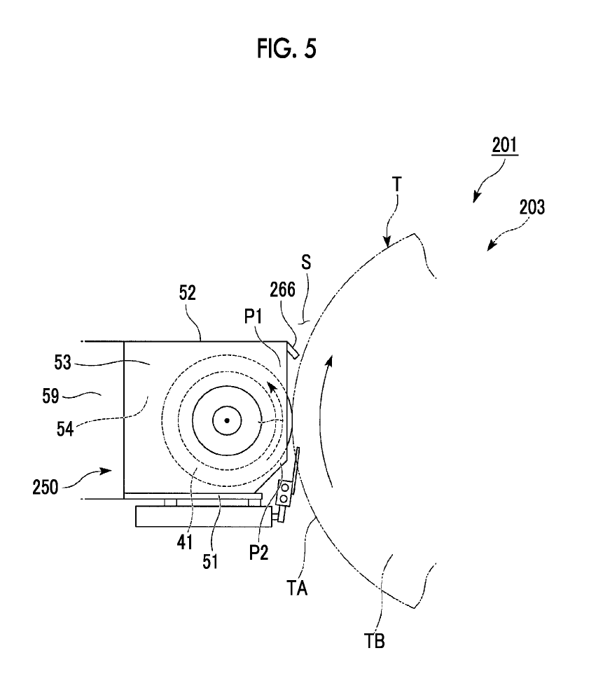

Next, a second modification example of the above-described embodiment will be described mainly with reference to FIG. 5.

In this modification example, the same reference numerals are assigned to the same members as the members used in the above-described embodiment and modification examples, and descriptions thereof are omitted.

A tire grinding device 203 according to the second modification example grinds the tread portion TA of the tire T.

A cover 250 includes the first wall portion 51, the second wall portion 52, the third wall portion 53, and the fourth wall portion 54.

The first wall portion 51, the second wall portion 52, the third wall portion 53, and the fourth wall portion of the cover 250 are disposed so as to cover the periphery of the grindstone 41.

The gap S is formed between the surface of the tire T and the end portion of the first wall portion 51 of the cover 50, between the surface of the tire T and the end portion of the second wall portion 52, between the surface of the tire T and the end portion of the third wall portion 53, between the surface of the tire T and the fourth wall portion 54, and over the front side in the grinding direction and the rear side in the grinding direction from the contact surface between the tread portion TA of the tire T and the grindstone 41.

A nozzle 266 is formed in a tapered shape, and is attached to the end portion of the second wall portion 52. The tip of the nozzle 266 is disposed so as to be directed toward the gap S. The air layer is formed by the air injected from the nozzle 66, and the air layer prevents the ground chips of the tire T from being discharged from the gap S formed between the edge of the cover 250 and the surface of the tire T.

In the present modification example, the tip of the nozzle 266 is disposed so as to be gradually directed to the grindstone 41 side toward the tire T. In order words, the tip of the nozzle 266 is disposed so as to be gradually directed to the rear side P2 in the grinding direction toward the tire T. In addition, the nozzle 266 is disposed so as to inject the air toward the portion of the front side P1 in the grinding direction from the tread portion TA in the gap S extending in the grinding direction in the state where the tread portion TA of the tire T which is the contact surface between the grindstone 41 and the tire T is interposed.

In a tire testing system 201 configured in this way, using the air injected from the tip of the nozzle 266 toward the gap S, the tread portion TA of the tire T can be ground, and the ground chips are sucked into the duct 59.

In addition, the tire grinding device may be configured so as to grind the side wall portion TB of the tire T.

### THIRD MODIFICATION EXAMPLE

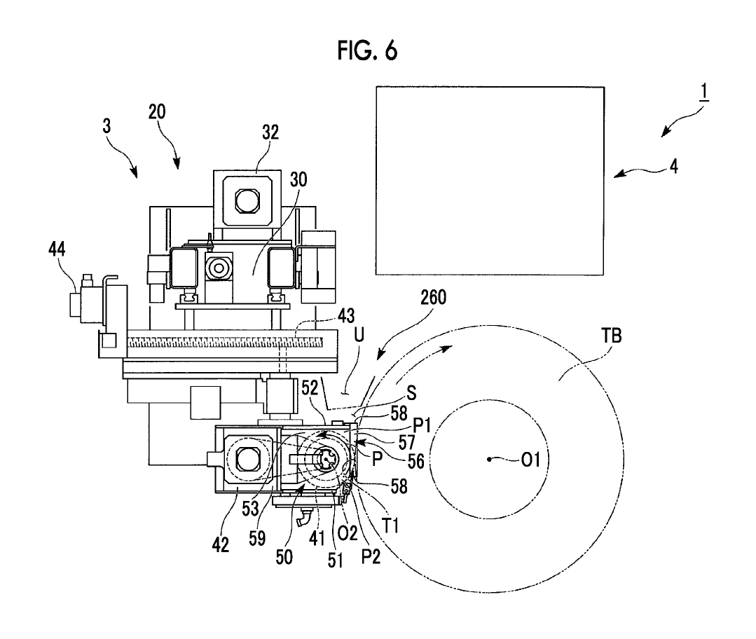

In the above-described embodiment, the configuration is described in which the nozzle 66 supplying the ionized air to the gap S is provided as the air layer forming portion 60. However, the embodiment of the present invention is not limited to this. For example, as the air layer forming portion 60, a configuration may be adopted in which an external space portion U (refer to FIG. 6) provided outside the gap S and the gap S are separated from each other, and a pressure of the external space U is set so as to be higher than a pressure of the gap S. In this case, since the pressure of the external space portion U is higher than the pressure of the gap S, the ground chips generated from the tire T are not scattered to the external space portion U which is disposed outside the gap S. Since the ground chips receive the pressure in the direction directed from the external space portion U to the gap S and are introduced into the cover 50, the scattering of the ground chips is prevented.

### INDUSTRIAL APPLICABILITY

According to the above-described tire grinding device 3 and the tire testing system 1, it is possible to prevent the ground chips from being scattered when the tire T is ground.

1. A tire grinding device which grinds a surface of a tire, comprising:
a grindstone holding portion which holds a grindstone which grinds the surface of the tire;
a cover which is disposed with a gap with respect to the surface of the tire, and covers the grindstone held by the grindstone holding portion; and
an air layer forming portion which forms an air layer which prevents ground chips of the ground tire from being discharged through the gap formed between an edge of the cover and the surface of the tire.

2. The tire grinding device according to claim 1,
wherein the air layer forming portion injects air toward the gap.

3. The tire grinding device according to claim 2,
wherein the air layer forming portion injects the air toward the gap so that the air is gradually directed to the grindstone side toward the tire.

4. The tire grinding device according to claim 2,
wherein the air layer forming portion is provided so as to inject the air to at least a front side gap in a grinding direction in the gap.

5. The tire grinding device according to claim 2,
wherein the air layer forming portion injects the air toward the gap from the outside of the cover.

6. The tire grinding device according to claim 1,
wherein the grindstone holding portion holds the grindstone so as to grind a shoulder portion of the tire.

7. The tire grinding device according to claim 1, further comprising:
a static electricity removing portion which removes static electricity on the surface of the tire.

8. The tire grinding device according to claim 7,
wherein the air layer forming portion injects ionized air toward the gap, and also serves as the static electricity removing portion which removes the static electricity on the surface of the tire using the injected ionized air

9. A tire testing system, comprising:
a tire grinding device according to claim 1; and
a surface measurement device which measures the shape of the surface of the tire.
